(19) United States
(12) Patent Application Publication
(10) Pub. No.: US 2024/0117183 A1
(43) Pub. Date: Apr. 11, 2024

(54) BLOW-MOLDABLE POLYAMIDE COMPOSITIONS

(71) Applicant: INV Nylon Polymers Americas, LLC, Wilmington, DE (US)

(72) Inventors: Michael David Benstead, Stockton-on-Tees (GB); Anne Campeau Burley, Woodstock, GA (US); Patrick Cazuc, PREVESSIN (FR); Isaac K. Iverson, Wichita, KS (US); Chee-Sern Lim, Kennesaw, GA (US)

(21) Appl. No.: 18/276,262

(22) PCT Filed: Feb. 7, 2022
(86) PCT No.: PCT/IB2022/051045

§ 371 Date: Aug. 8, 2023

Related U.S. Application Data
(60) Provisional application No. 63/146,819, filed on Feb. 8, 2021.

(51) Int. Cl. C08L 77/06; B29C 49/00

(52) U.S. Cl. CPC C08L 77/06; B29C 49/0005; B29K 2077/00; C08L 2205/025; C08L 2205/03

(57) ABSTRACT

The present disclosure relates to blow-moldable compositions, methods of making and using the same, and blow molded articles formed from the blow-moldable compositions. A blow-moldable composition includes a polyamide composition, a reacted composition that is a reaction product of the polyamide composition, or a combination thereof. The polyamide composition includes ≥30 wt % to ≤90 wt % polyamide-6,6 and from ≥0 wt % to ≤2 wt % of a reinforcing fiber.

### CROSS-REFERENCE TO RELATED APPLICATION

This application claims the benefit of priority to U.S. Provisional Patent Application Ser. No. 63/146,819 filed Feb. 8, 2021, the disclosure of which is incorporated herein in its entirety by reference.

### FIELD

The present disclosure provides a condensation polyamide composition suitable for blow molding, methods for making the compositions and parts blow-molded from the composition.

### BACKGROUND

Thermoplastic condensation polyamide resins that are molded or extruded suffer from insufficient properties for various end uses such as automotive, electronics, chemical processing, and heat transfer applications. Various thermoplastic condensation polyamide resins that are molded or extruded have lower tensile strength, lower chemical resistance, lower stress cracking resistance, or higher melt viscosities (e.g., making extrusion difficult or impossible), than available HDPE, N11, N12, N612 and PVDF materials. One of the technical problems in the blow molding thermoplastics is the formation of imperfections in the formed polymer parison. These imperfections can promote localized areas of stress concentration and trigger wall failures, either upon formation of the parison or during the subsequent blow molding steps.

In the industry, several commercial nylon polymer offerings are available for 2-dimensional and 3-dimensional blow molding applications. However, these typically work with some reinforcement, for example, 15 wt. % or 20 wt. % or 30 wt. % glass fiber. The use of unreinforced nylon polymers in the blow molding process is usually met with undesirable and unacceptable molded part quality.

There continues to be a need for an unreinforced condensation polyamide resin composition that is suitable for making 2-dimensional and 3-dimensional parts and articles of various shapes via blow molding process. Such unreinforced polyamide resins need to provide good melt strength and crystallization behavior that is suitable for extrusion blow molding, injection blow molding, injection stretch blow molding, suction blow molding, and such processes.

### SUMMARY OF THE INVENTION

In various aspects, the present invention provides a blow-moldable composition. The blow-moldable composition includes a polyamide composition, a reacted composition that is a reacted product of the polyamide composition, or a combination thereof. The polyamide composition includes ≥30 wt % to ≤90 wt % polyamide-6,6, from ≥0 wt % to ≤2 wt % of a reinforcing fiber, and from ≥10 wt % to ≤50 wt % of a maleic anhydride-grafted polyolefin. The maleic anhydride-grafted polyolefin has a grafted maleic anhydride incorporation of ≥0.05 to ≤1.5 wt % based on total weight of the maleic anhydride-grafted polyolefin.

In various aspects, the present invention provides a blow-moldable composition. The blow-moldable composition includes a polyamide composition, a reacted composition that is a reaction product of the polyamide composition, or a combination thereof. The polyamide composition includes ≥30 wt % to ≤90 wt % polyamide-6,6, from ≥0 wt % to ≤10 wt % of a reinforcing fiber, and from ≥0 to ≤1 wt % of nylon-6. The blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

In various aspects, the present invention provides a blow-moldable composition. The blow-moldable composition includes a polyamide composition, a reacted composition that is a reaction product of the polyamide composition, or a combination thereof. The polyamide composition includes ≥30 wt % to ≤90 wt % polyamide-6,6, and from ≥0 wt % to ≤10 wt % of a reinforcing fiber. The blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

In various aspects, the present invention provides a blow-moldable composition. The blow-moldable composition includes a polyamide composition, a reacted composition that is a reaction product of the polyamide composition, or a combination thereof. The polyamide composition includes ≥40 wt % to ≤50 wt % polyamide-6,6, from ≥0 wt % to ≤2 wt % of a reinforcing fiber, PA66/DI that is from ≥25 wt % to ≤35 wt % of the polyamide composition, and from ≥10 wt % to ≤50 wt % of a maleic anhydride-grafted polyolefin. The maleic anhydride-grafted polyolefin has a grafted maleic anhydride incorporation of ≥0.05 to ≤1.5 wt % based on total weight of the maleic anhydride-grafted polyolefin. The blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

In various aspects, the present invention provides a blow molded article. The blow molded article includes a polyamide composition, a reacted composition that is a reaction product of the polyamide composition, or a combination thereof. The polyamide composition includes ≥40 wt % to ≤50 wt % polyamide-6,6, from ≥0 wt % to ≤2 wt % of a reinforcing fiber, PA66/DI that is from ≥25 wt % to ≤35 wt % of the polyamide composition, and from ≥10 wt % to ≤50 wt % of a maleic anhydride-grafted polyolefin. The maleic anhydride-grafted polyolefin has a grafted maleic anhydride incorporation of ≥0.05 to ≤1.5 wt % based on total weight of the maleic anhydride-grafted polyolefin.

In various aspects, the present invention provides a method of making the blow-moldable composition described herein. The method includes combining polyamide-6,6 and maleic anhydride-grafted polyolefin to form the blow-moldable composition.

In various aspects, the present invention provides a method of making a blow molded article from the blow-moldable composition described herein. The method includes blow molding the blow-moldable composition to form the blow molded article.

Various aspects of the present invention provide certain advantages over other blow-moldable compositions and article including the same. In various aspects, the blow-moldable composition of the present invention solves the problem that no condensation polyamide-based or nylon-6,6-based blow-moldable compositions are available that are substantially free of reinforcing fibers such as glass fibers. Conventional condensation polyamide-based or nylon-6,6-based compositions do not have sufficient melt strength required for blow molding. Glass fibers can make compounding of the composition less efficient and more tedious, and can make recycling and/or reuse of the blow molded material difficult or impossible such as due to the chopping and/or reorientation of fibers during a recycling process. In various aspects, the blow-moldable composition of the present invention is free of reinforcing fibers such as glass fibers and is therefore easier to compound and prepare. In various aspects, the blow-moldable composition of the present invention can have sufficient melt strength and crystallization behavior to form a stable parison for blow molding applications. In various aspects, articles formed from the blow-moldable composition of the present invention can be recycled and/or reused such as to make more of the blow-moldable composition, wherein subsequent articles formed from the recycled article have substantially the same physical properties as the original blow-molded article. In various aspects, the blow-moldable composition of the present invention can be used to form articles that can serve as replacements for metal articles, that can have advantageously lower weight than corresponding articles formed from metal or other blow-moldable compositions, and/or that can provide advantageous physical, mechanical, and/or chemical properties at lower cost than articles formed from other blow-moldable compositions such as PA12 or PEEK.

### BRIEF DESCRIPTION OF THE FIGURES

The drawings illustrate generally, by way of example, but not by way of limitation, various aspects of the present invention.

FIG. 1 illustrates a parison, in accordance with various aspects of the present invention.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

As used herein, the term “polymer” refers to a molecule having at least one repeating unit and can include copolymers.

The term “PA6”, “N6” or “nylon 6”, as used herein, refers to a polymer synthesized by polycondensation of caprolactam. The polymer is also known as polyamide 6 or poly(caprolactam).

The term “PA66”, “N66” or “nylon-6,6”, as used herein, refers to a polymer synthesized by polycondensation of hexamethylenediamine (HMID) and adipic acid. The polymer is also known as Polyamide 66, Nylon 66, nylon 6-6, nylon 6/6 or nylon-6,6.

As used herein, “PA66/DI” or “nylon-66/DI” or “PA66/MPMD-I” refers to a type of co-polyamide of polyhexamethyleneadipamide (nylon-6,6 or N66 or PA66) and “DI” which is a combination of 2-methyl-pentamethylenediamine (“MPMD”) and isophthalic acid. MPMD is commercially available as INVISTA Dytek® A amine and industrially known as “D” in the abbreviated formulation labeling. Isophthalic acid is commercially available and industrially known as “I” in the abbreviated formulation labeling. PA66/DI can be formed by combining N66 salt solution with DI salt solution.

INVISTA Dytek® A amine is commercially produced by hydrogenating 2-methylglutaronitrile (or “MGN”). MGN is a branched C6 dinitrile obtained as a side-product from butadiene double-hydrocyanation process of adiponitrile (or “ADN”) manufacture. The otherwise disposed MGN side-product can be recycled and reused in the production of INVISTA Dytek® A amine or the “D” portion; the PA66/DI produced by this process, therefore, is considered to have the recycled amine content coming from the “D” portion.

As used herein, “nylon 66/6T” refers to a type of partially aromatic polyamide that is commercially available from manufacturers including Arkema, BASF, DuPont, DSM and EMS. PA 66/6T is a type of co-polyamide prepared from PA66 and “6T”. The 6T part is a combination of hexamethylene diamine and terephthalic acid “T”.

### Blow-Moldable Composition.

Various aspects of the present invention provide a blow-moldable composition. The blow-moldable composition can include a polyamide composition, a reacted composition that is a reaction product of the polyamide composition, or a combination thereof. The blow-moldable composition can include the polyamide composition. The blow-moldable composition can include the reacted composition. The blow-moldable composition can include a combination of the polyamide composition and the reacted composition. The polyamide composition, the reacted composition, or the combination thereof, can be 100 wt % of the blow-moldable composition. The polyamide composition can include ≥30 wt % to ≤90 wt % polyamide-6,6. The polyamide composition can include ≥0 wt % to ≤10 wt % reinforcing fibers, ≥0 wt % to ≤5 wt %, ≥0 wt % to ≤2 wt %, ≥0 wt % to ≤1 wt %, or ≥0 wt % to ≤0.1 wt % reinforcing fibers.

The polyamide composition includes polyamide-6,6. For example, the polyamide-6,6 can be ≥30 wt % to ≤90 wt % of the polyamide composition, or ≥30 wt % to ≤70 wt %, or ≥40 wt % to ≤50 wt % of the polyamide composition, or less than or equal to 90 wt % and greater than or equal to 30 wt %, 32, 34, 36, 38, 40, 42, 44, 46, 48, 50, 52, 54, 56, 58, 60, 62, 64, 66, 68, 70, 72, 74, 76, 78, 80, 82, 84, 86, or 88 wt %. The polyamide-6,6 can be any suitable polyamide-6,6. The polyamide-6,6 can have any suitable amount of amine end groups (AEG), such as an AEG of ≥65 milliequivalents per kg (meq/kg) and ≤130 meq/kg, or ≥80 meq/kg and ≤125 meq/kg, ≥80 meq/kg and ≤120 meq/kg, or less than or equal to 130 meq/kg but greater than or equal to 65 meq/kg, 70, 75, 80, 85, 90, 95, 100, 105, 110, 115, 120, or 125 meq/kg. The polyamide-6,6 can have any suitable relative viscosity (RV), such as determined via a formic acid method (e.g., ASTM D789), such as equal to or greater than 35, 40, or 45, or such as equal to or less than 100, 90, or 80, or such as less than or equal to 100 but equal to or greater than 20, 22, 24, 26, 28, 30, 31, 32, 33, 34, 35, 36, 37, 38, 39, 40, 41, 42, 43, 44, 45, 46, 47, 48, 49, 50, 55, 60, 65, 70, 75, 80, 85, 90, or 95, or such as 20-80, 25-75, or 30-50, or such as 20-100, 25-90, or 30-80. In some aspects, the polyamide composition is substantially free of polyamides other than polyamide-6,6. In some aspects, the polyamide composition includes one or more other polyamides other than polyamide-6,6, such as a PA66 copolymer.

The polyamide composition can be substantially free of reinforcing fibers, such as glass fibers and/or other reinforcing fibers. For example, the polyamide composition can be ≥0 wt % to ≤10 wt % reinforcing fibers, ≥0 wt % to ≤5 wt %, ≥0 wt % to ≤2 wt %, ≥0 wt % to ≤1 wt %, or ≥0 wt % to ≤0.1 wt % reinforcing fibers, or less than or equal to 10 wt % and greater than or equal to 0 wt %, 0.1, 1, 2, 3, 4, 5, 6, 7, 8, or 9 wt % reinforcing fibers. The polyamide composition can be ≥0 wt % to ≤10 wt % glass fibers, ≥0 wt % to ≤5 wt %, ≥0 wt % to ≤2 wt %, or ≥0 wt % to ≤1 wt %, ≥0 wt % to ≤0.1 wt % glass fibers, or less than or equal to 10 wt % and greater than or equal to 0 wt %, 0.1, 1, 2, 3, 4, 5, 6, 7, 8, or 9 wt % glass fibers.

The polyamide composition can include a maleic anhydride-grafted polyolefin. The maleic anhydride-grafted polyolefin can form any suitable proportion of the polyamide composition, such as from ≥10 wt % to ≤50 wt %, ≥15 wt % to ≤40 wt %, ≥25 wt % to ≤35 wt %, or less than or equal to 50 wt % and greater than or equal to 10 wt %, 12, 14, 16, 18, 20, 21, 22, 23, 24, 25, 26, 27, 28, 29, 30, 31, 32, 33, 34, 35, 36, 38, 40, 42, 44, 46, or 48 wt %. The maleic anhydride-grafted polyolefin includes a polyolefin or polyacrylate backbone having pendant maleic anhydride groups grafted thereto. The polyolefin component can optionally be an ionomer. The polyolefin can be any suitable polyolefin polymer or copolymer. The polyolefin can include EPDM, ethylene-octene, polyethylene, polypropylene, or a combination thereof. In various aspects, the maleic anhydride-grafted polyolefin is free of EPDM. The maleic anhydride-grafted polyolefin can have any suitable grafted maleic anhydride incorporation, such as a grafted maleic anhydride incorporation of less than 10 wt %, or of 0.01 to 10 wt %, based on total weight of the maleic anhydride-grafted polyolefin, such as ≥0.05 to ≤1.5 wt %, ≥0.1 to ≤1.4 wt %, ≥0.15 to ≤1.25 wt %, or less than or equal to 1.5 wt % but equal to or greater than 0.05 wt %, 0.05, 0.1, 0.2, 0.3, 0.4, 0.5, 0.6, 0.7, 0.8, 0.9, 1, 1.1, 1.2, 1.3, 1.4, or 1.5 wt %. The maleic anhydride-grafted polyolefin can have any suitable glass transition temperature (T_{g}), such as ≥−70° C. to ≤0° C., ≥−60° C. to ≤−20° C., ≥−60° C. to ≤−30° C., or less than or equal to 0° C. but greater than or equal to −70° C., −65, −60, −55, −50, −45, −40, −35, −30, −25, −20, −15, −10, or −5° C. The maleic anhydride-grafted polyolefin, or domains thereof, can be uniformly distributed in the polyamide composition and/or the reacted product thereof.

The maleic anhydride-grafted polyolefin can be any suitable maleic anhydride-grafted polyolefin. A variety of maleic anhydride-grafted polyolefins are commercially available. These may include, but are not limited to, AMPLIFY™ GR Functional Polymers commercially available from Dow Chemical Co. (Amplify™ GR 202, Amplify™ GR 208, Amplify™ GR 216, Amplify™ GR380), Exxelor™ Polymer Resins commercially available from ExxonMobil (Exxelor™ VA 1803, Exxelor™ VA 1840, Exxelor™ VA1202, Exxelor™ PO 1020, Exxelor™ PO 1015), ENGAGE™ 8100 Polyolefin Elastomer commercially available from Dow Elastomer, Bondyram® 7103 Maleic Anhydride-Modified Polyolefin Elastomer commercially available from Ram-On Industries LP, and such. Table 1 lists non-limiting commercially available modified polyolefins.

TABLE 1
Commercially available modified polyolefins.

| | | Modification |
|---|---|---|
| | Commercial Manuf./ | Level (wt %) |
| Polyolefin | Trade Name | in Polyolefin |
| Polypropylene | ExxonMobil/Exxelor ™ | 0.2-0.5 |
| | VA1840 | |
| Polypropylene | Ram-On Industries/ | <1 |
| | Bondyram ® 7103 | |
| Very low-density | Dow Chemicals/Amplify ™ | 0.25-0.5 |
| Polyethylene [vLDPE] | GR208 | |
| Polypropylene | ExxonMobil/Exxelor ™ | 0.25-0.5 |
| | PO1015 | |
| Ethylene alpha olefin | ExxonMobil/Exxelor ™ | 0.5-1 |
| | VA1202 | |
| Ethylene octene | Dow Chemicals/Amplify ™ | 0.5-1 |
| | GR216 | |
| Pure Ethylene | ExxonMobil/Exxelor ™ | 0.5-1 |
| | VA1803 | |
| Low-density | Dow Chemicals/Amplify ™ | >1 |
| Polyethylene [LDPE] | GR202 | |

In Table 1, the term “Modification Level (wt %) in Polyolefin” means the functionalized level in the polyolefin tested. For example, in the first row of Table 1, polypropylene with 0.2-0.5 wt % modification level means it is a modified polyolefin having 0.2-0.5% grafted maleic anhydride content.

The polyamide composition can further include a PA66 copolymer. The PA66 copolymer can form any suitable proportion of the polyamide composition, such as ≥0 wt % to ≤50 wt %, ≥10 wt % to ≤50 wt %, ≥25 wt % to ≤35 wt % of the polyamide composition. Or less than or equal to 50 wt % and greater than or equal to 0 wt %, 2, 4, 6, 8, 10, 12, 14, 16, 18, 20, 21, 22, 23, 24, 25, 26, 27, 28, 29, 30, 31, 32, 33, 34, 35, 36, 37, 38, 39, 40, 42, 44, 46, or 48 wt %. The PA66 copolymer can include any suitable PA66 copolymer, such as nylon 66/6T, nylon 66/DI, nylon 66/D6, nylon 66/DT, nylon 66/610, nylon 66/612. The PA66 copolymer can be PA66/DI.

The polyamide composition can include a chain extender. The chain extender can be capable of reacting with the amine and/or acid terminal groups of the PA66, any PA66 copolymer, and/or of the reaction product thereof with the maleic anhydride-grafted polyolefin, thereby connecting two polyamide chains. The chain extender can be any suitable chain extender, such as a dialcohol (e.g., ethylene glycol, propanediol, butanediol, hexanediol, or hydroquinone bis(hydroxyethyl)ether), a bis-epoxide (e.g., bisphenol A diglycidyl ether), polymers having epoxide functional groups (e.g., as pendant and/or terminal functional groups), polymers including anhydride functional groups, bis-N-acyl bis-caprolactams (e.g., isophthaloyl bis-caprolactam (IBS), adipoyl bis-caprolactam (ABC), or terephthaloyl bis-caprolactam (TBC)), diphenyl carbonates, bisoxazolines, oxazolinones, diisocyanates, organic phosphites (triphenyl phosphite, caprolactam phosphite), bis-ketenimines, or dianhydrides. The chain extender can be a polymer including anhydride functional groups, such as a maleic anhydride-polyolefin copolymer (e.g., an alternating copolymer of maleic anhydride and ethylene). The chain extender can be any suitable proportion of the polyamide composition, such as ≥0.05 to ≤5 wt %, ≥0.05 to ≤2 wt % of the polyamide composition, ≥0.1 wt % to ≤1 wt % of the polyamide composition, or less than or equal to 5 wt % but greater than or equal to 0.05 wt %, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, 3, 3.2, 3.4, 3.6, 3.8, 4, 4.2, 4.4, 4.6, or 4.8 wt %. The chain extender and/or domains thereof can be uniformly distributed in the polyamide composition and/or the reacted product thereof.

The polyamide composition can further include a modified polyphenylene ether, an impact modifier, a flame retardant, a chain extender, a heat stabilizer (e.g., Zytel® additives (DuPont), Irganox® sterically hindered additives (BASF), and such), a colorant additive, a filler, a conductive fiber, glass fibers, another polyamide other than the polyamide-6,6 and/or PA66 copolymer, or a combination thereof. Non-limiting examples of optional additives that can be included in the polyamide composition include adhesion promoters, biocides, anti-fogging agents, anti-static agents, anti-oxidants, bonding, blowing and foaming agents, catalysts, dispersants, extenders, smoke suppressants, impact modifiers, initiators, lubricants, nucleants, pigments, colorants and dyes, optical brighteners, plasticizers, processing aids, release agents, silanes, titanates and zirconates, slip agents, anti-blocking agents, stabilizers, stearates, ultraviolet light absorbers, waxes, catalyst deactivators, and combinations thereof.

The polyamide composition can further include nylon-6, or can be substantially free of nylon-6. For example, the blow-moldable composition can further include from ≥0 to ≤1% by weight of nylon-6, or 0 wt % of nylon-6.

The blow-moldable composition can exhibit sufficient melt strength to form a parison in a blow molding apparatus, wherein the parison hangs substantially vertically. The blow-moldable composition can form a parison that remains substantially stable in an open split mold of a blow molding process for time ≥1 second and ≤60 seconds. The parison can be blow-moldable at ratios of volume to surface area of ≥2 and ≤20, or ≥10 and ≤20, or ≥2 and ≤4, or less than or equal to 20 and greater than or equal to 2, 3, 4, 5, 6, 7, 8, 9, 10, 11, 12, 13, 14, 15, 16, 17, 18, or 19. A parison formed from the blow-moldable composition retains sufficient melt strength under blow molding conditions to form a continuous hollow blow-molded molding having a wall thickness of ≥0.5 mm to ≤20 mm, such as less than or equal to 20 and greater than or equal to 0.5 mm, 1, 2, 3, 4, 5, 6, 8, 10, 12, 14, 16, or 18 mm. A parison formed from the blow-moldable composition can retain sufficient strength to form a continuous hollow blow-molded molding having aspect ratios from ≥0.5 to ≥75, such as less than or equal to 75 and greater than or equal to 0.5, 1, 2, 3, 4, 5, 6, 8, 10, 12, 14, 16, 18, 20, 25, 30, 35, 40, 45, 50, 55, 60, 65, or 70. An aspect ratio is defined as an arithmetic ratio of the overall linear length of a shaped article over its diametric distance.

The term “stable parison test”, as used herein, describes a test to determine whether a composition is blow-moldable. The blow-moldable composition of the present invention can pass the stable parison test. In some aspects, the composition passes the stable parison test if the composition is extrudable downwardly into a parison having a wall thickness of Wᵢ at a linear extrusion rate of 6-8 cm/sec to a length of 1 meter, and the wall thickness throughout differs from Wᵢ by less than 30% of Wᵢ for at least 30 seconds after the hanging length of the parison reaches 1 meter, such as wherein the wall thickness throughout differs from Wᵢ by less than 30% of Wᵢ, 29%, 28, 27, 26, 25, 24, 23, 22, 21, 20, 19, 18, 17, 16, 15, 14, 13, 12, 11, 10, 9, 8, 7, 6, 5, 4, 3, 2, or by less than 1% of Wᵢ for at least 30 seconds after the hanging length of the parison reaches 1 meter. In some aspects, a composition passes the stable parison test if the composition is extrudable downwardly into a parison having a 7 mm wall thickness and a 25 mm outside diameter at a linear extrusion rate of 6-8 cm/sec to a length of 1 meter, and the wall thickness throughout remains above 6 mm and below 8 mm for at least 30 seconds after the hanging length of the parison reaches 1 meter. During the stable parison test, any suitable temperature can be used for the extrusion of the composition, such as 260° C. to 310° C., or 275° C. to 290° C., or less than or equal to 310° C. and greater than or equal to 260° C., 265, 270, 275, 280, 285, 290, 295, 300, or 305° C. The stable parison test is conducted without pressure or vacuum applied to the inside or outside of the parison. The stable parison test is conducted with the parison being pulled down only by the force of gravity and without any other external forces on the parison.

In various aspects, a blow molded article formed from the blow-moldable composition can be processed and reused to form the blow-moldable composition of the present invention. Any suitable proportion of the polyamide composition can be the reused material, such as 0 wt %, or such as 0.01 wt % to 100 wt %, or 30 wt % to 100 wt %, or 30 wt % to 80 wt %, or less than or equal to 100 wt % and greater than or equal to 0 wt %, 0.01, 0.1, 1, 2, 3, 4, 5, 6, 8, 10, 12, 14, 16, 18, 20, 25, 30, 35, 40, 45, 50, 55, 60, 65, 70, 75, 80, 85, 90, or 95 wt %. Before incorporation into the polyamide composition, the blow-molded article can be ground or otherwise formed into particles. The particles can have any suitable size, such as 10 mm or less, or equal to or less than 9 mm, 8, 7, 6, 5, 4, 3, 2, or 1 mm. Parisons and blow-molded articles formed from the blow-moldable composition that includes the reused material can have substantially the same properties as the original blow-molded article and/or the same properties as a blow-molded article formed from the blow-moldable composition that is substantially free of reused material. For example, a parison formed from the blow-moldable composition can have a swell ratio that is substantially the same as a swell ratio of a parison formed during formation of the blow-molded article that is reused in the blow-moldable composition, such having a difference that is equal to or less than 10% of the largest swell ratio, or equal to or less than 9%, 8, 7, 6, 5, 4, 3, 2, or 1% of the largest swell ratio.

### Reacted Polyamide Composition.

The blow-moldable composition can include a reacted composition that is a reaction product of the polyamide composition. The reacted composition can include a reaction product of the polyamide-6,6 and the maleic anhydride-grafted polyamide, a reaction product of the PA66 copolymer (if present) and the maleic anhydride-grafted polyamide, a reaction product of the polyamide-6,6 and maleic anhydride-polyolefin copolymer (if present), a reaction product of the PA66 copolymer (if present) and maleic anhydride-polyolefin copolymer (if present) or a combination thereof. The reacted composition can include a polyamide-polyolefin copolymer formed from at least partial reaction of the polyamide-6,6 and/or PA66 copolymer with the maleic anhydride-grafted polyolefin and/or maleic anhydride-polyolefin copolymer.

The reacted composition can include the composition including the polyamide-6,6 and/or PA66 copolymer and the maleic anhydride-grafted polyolefin and/or maleic anhydride-polyolefin copolymer wherein any suitable proportion of the polyamide-6,6 and/or PA66 copolymer has reacted with the maleic anhydride-grafted polyolefin and/or maleic anhydride-polyolefin copolymer. For example, the reacted composition can include the polyamide-polyolefin copolymer in a concentration range of ≥50 to ≤7500 ppmw, ≥100 to ≤4900 ppmw, ≥225 to ≤3750 ppmw, or less than or equal to 7500 ppmw but greater than or equal to 50, 100, 250, 500, 750, 1,000, 1,500, 2,000, 2,500, 3,000, 3,500, 4,000, 4,500, 5,000, 6,000, 7,000, or 8,000 ppmw. In some aspects, the amount of polyamide-polyolefin copolymer can be calculated by multiplying the concentration of the maleic anhydride-grafted polyolefin with the modification level of the maleic anhydride-grafted polyolefin. For example, for a reacted composition made from 80:20 (wt:wt) polyamide polymer/copolymer:modified polyolefin having 0.5 wt. % grafted maleic anhydride modification, the total reacted polyamide-modified polyolefin functionality in the sample formed from the maleic anhydride-grated polyolefin (assuming all grafted maleic anhydride reacts, which may not occur) can be calculated as (0.20)*(0.005)*10⁶=1000 ppmw.

The reacted composition can include the same components in the same proportions as the composition including the polyamide-6,6 and/or PA66 copolymer and the maleic anhydride-grafted polyolefin and/or maleic anhydride-polyolefin copolymer, with the exception that the polyamide-6,6 and/or PA66 copolymer and the maleic anhydride-grafted polyolefin and/or maleic anhydride-polyolefin copolymer are at least partially reacted.

As described herein, without limiting the scope of the disclosure with a recitation of a theoretical mechanism, the generalized chemical reaction schematically represented in Scheme 1 is one approach to understand the interaction of a maleic anhydride-grafted polyolefin with a polyamide.

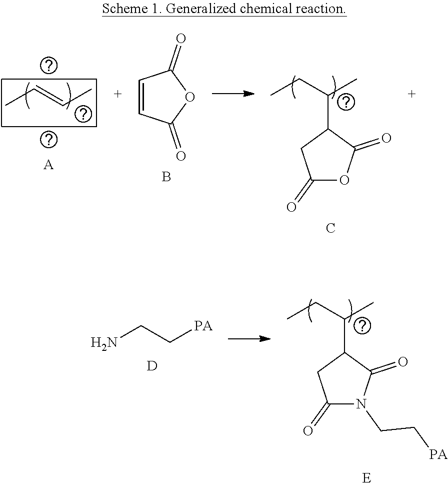

Structure D is a polyamide. Polyamide is a type of synthetic polymer made by the linkage of an amino group of one molecule and a carboxylic acid group of another. Polyamides are also generically referred to as nylons.

For the chemistry disclosed herein and throughout this disclosure; the olefin copolymer (structure A) may be any copolymer of ethylene, propylene, or butylene. The olefin copolymer may contain a suitable degree of maleation, e.g., maleic anhydride content, for example, between 0.05 to 1.5% by weight. This material can be referred to as “maleic anhydride-grafted polyolefin” (structure C).

The term “reacted Polyamide-Polyolefin copolymer” or “modified polyamide” (structure E), as used herein is the reacted portion of the polyolefin and the polyamide matrix. This is dependent upon the original maleation content of the polyolefin additive (structure C).

The term “degree of maleation” or “modification level”, as used interchangeably herein, means the extent of which the olefin copolymer (structure A) has been reacted with maleic anhydride (structure B).

The polyamide-polyolefin copolymer formed from at least partial reaction of the polyamide-6,6 and/or PA66 copolymer and the maleic anhydride-grafted polyolefin is structure E.

The maleic anhydride-grafted polyolefin and/or maleic anhydride-polyolefin copolymer, polyolefin, domains thereof, or reaction products thereof with the polyamide-6,6 and/or PA66 copolymer, can have any suitable distribution in the polyamide compositions or reacted product thereof. For example, the maleic anhydride-grafted polyolefin and/or maleic anhydride-polyolefin copolymer, or domains thereof, can have a uniform or homogeneous distribution in the polyamide composition or reacted product thereof on a molecular level, such that the molecules of the maleic anhydride-grafted polyolefin and/or maleic anhydride-polyolefin copolymer are homogeneously distributed therein. The maleic anhydride-grafted polyolefin and/or maleic anhydride-polyolefin copolymer or reaction product thereof can forms domains within the polyamide composition or reacted product thereof; in some aspects, the maleic anhydride-grafted polyolefin and/or maleic anhydride-polyolefin copolymer or reaction product thereof can be at least partially immiscible with the polyamide-6,6 and/or PA66 copolymer. For example, the polyamide-6,6 and/or PA66 copolymer, or all polymeric components other than the maleic anhydride-grafted polyolefin and/or maleic anhydride-polyolefin copolymer, or the remainder of the polyamide composition or reacted product thereof, can form a continuous phase, and the maleic anhydride-grafted polyolefin and/or maleic anhydride-polyolefin copolymer can form a discontinuous phase (domains) therein. In various aspects, the polyamide composition or reaction product thereof can include a uniform or homogeneous distribution of the maleic anhydride-grafted polyolefin and/or maleic anhydride-polyolefin copolymer, reaction products thereof, or domains of the maleic anhydride-grafted polyolefin and/or maleic anhydride-polyolefin copolymer or reaction products thereof.

In various aspects, blow molded articles formed from the blow-moldable composition described herein, can include a uniform or homogeneous distribution of the maleic anhydride-grafted polyolefin and/or maleic anhydride-polyolefin copolymer, reaction products thereof, or domains of the maleic anhydride-grafted polyolefin and/or maleic anhydride-polyolefin copolymer or reaction products thereof.

### Article.

Various aspects of the present invention provide a blow molded article that is blow molded from the blow-moldable composition described herein. The blow molded article can be any suitable blow molded article that can be blow molded from the blow-moldable composition described herein. In various aspects, the blow molded article can have a wall thickness in the range ≥0.5 mm to ≤20 mm, such as less than or equal to 20 and greater than or equal to 0.5 mm, 1, 2, 3, 4, 5, 6, 8, 10, 12, 14, 16, or 18 mm. The article can have aspect ratios from ≥0.5 to ≥75, such as less than or equal to 75 and greater than or equal to 0.5, 1, 2, 3, 4, 5, 6, 8, 10, 12, 14, 16, 18, 20, 25, 30, 35, 40, 45, 50, 55, 60, 65, or 70. An aspect ratio is defined as an arithmetic ratio of the overall linear length of a shaped article over its diametric distance.

### Method of Making Blow-Moldable Composition.

Various aspects of the present invention provide a method of making the blow-moldable composition described herein. The method can include combining the polyamide-6,6, and the maleic anhydride-grafted polyolefin to form the blow-moldable composition. A method of forming the article can include making the blow-moldable composition; alternatively, the blow-moldable composition can be pre-formed before the onset of a method of forming the article.

In various aspects, the method includes combining the polyamide-6,6 and the maleic anhydride-grafted polyolefin (e.g., and allowing the two to at least partially react to form a reaction product thereof) before adding a chain extender thereto. In other aspects, the method of making the blow-moldable composition includes combining the polyamide-6,6, the maleic anhydride-grafted polyolefin, and the chain extender at once without allowing any extra time for the polyamide-6,6 and the maleic anhydride-grafted polyolefin to react.

In various aspects, the method includes providing to a first compounder extruder zone a feed including the polyamide-6,6 and the maleic anhydride-grafted polyolefin. The method can include maintaining the first compounder extruder zone conditions sufficient to obtain a first compounded polyamide melt inside the first compounder extruder zone. The method can include introducing a chain extender to the first compounded polyamide melt in a second compounder extruder zone. The method can include maintaining the second compounder extruder zone conditions sufficient to obtain a second compounded polyamide melt inside the second compounder extruder zone, wherein the second compounded polyamide melt is the blow-moldable composition described herein.

The first compounder extruder zone can be substantially free of the chain extender. The chain extender can be ≥0.01 to ≤5 wt % of the second compounded polyamide melt. The method can further include producing an article from the second compounded polyamide melt; for example, the method can include producing blow molding an article from the second compounded polyamide melt.

The extruder used to make the polyamide composition or the reacted product thereof can be a screw extruder (e.g., a single screw extruder, a vented twin-screw extruder, or an unvented twin-screw extruder). A barrel of the screw extruder can include the first compounder extruder zone and the second compounder extruder zone. Providing the feed to the first compounder extrusion zone can include providing the feed to a feed inlet of the barrel.

In various aspects, the chain extender can be introduced to the second compounder extruder zone in the barrel a suitable distance away from the feed inlet. For example, the chain extender can be introduced to the second compounder extruder zone at least ¼ of the length of the barrel from the feed inlet of the barrel. The chain extender can be introduced to the second compounder extruder zone at least ½ of the length of the barrel from the feed inlet of the barrel. The chain extender can be introduced to the second compounder extruder zone at least ¾ of the length of the barrel from the feed inlet of the barrel. The chain extender can be introduced to the second compounder extruder zone sufficiently far from an outlet of the barrel to provide mixing of the chain extender with the first compounded polyamide melt to form the second compounded polyamide melt, and equal to or greater than ¼ of the length of the barrel from the feed inlet of the barrel, or ½, ¾, or more. The chain extender can be introduced to the second compounder extruder zone sufficiently far from an outlet of the barrel to provide mixing of the chain extender with the first compounded polyamide melt to form the second compounded polyamide melt, and equal to or greater than 20% of the length of the barrel from the feed inlet of the barrel, or 30%, 40, 50, 60, 70, 80, 90, or 95% or more of the length of the barrel from the feed inlet of the barrel.

In various aspects, the introducing of the chain extender to the first compounded polyamide melt in the second compounder extruder zone can include introducing the chain extender to the first compounded polyamide melt after a certain weight percentage of the maleic anhydride-grafted polyolefin has incorporated into the polyamide composition. Incorporation into the polyamide composition can include homogeneous blending of the chain extender with the polyamide composition (e.g., on a molecular level, or of domains of the maleic anhydride-grafted polyolefin or a reaction product thereof), formation of a reaction product of the maleic anhydride-grafted polyolefin (e.g., with the polyamide-6,6 and/or PA66 copolymer), formation of domains of the maleic-anhydride-grafted polyolefin or a reaction product thereof in composition, or a combination thereof. The introducing of the chain extender to the first compounded polyamide melt in the second compounder extruder zone can include introducing the chain extender to the first compounded polyamide melt after at least 50 wt % of the maleic anhydride-grafted polyolefin fed has incorporated into the polyamide composition, or greater than or equal to 50%, 60%, 70%, 80%, 90%, greater than or equal to 95%, or after about 100% of the maleic anhydride-grafted polyolefin has incorporated into the polyamide composition.

### Method of Making a Blow Molded Article.

In various aspects, the present invention provides a method of making a blow molded article. The method includes making the blow molded article from the blow-moldable composition described herein. The method includes blow molding the blow-moldable composition described herein to form the blow molded article.

Devices for forming parisons in the blow molding of thermoplastics are disclosed in U.S. Pat. No. 4,696,636 to Everly et al., and are well known by those of ordinary skill in the art.

### EXAMPLES

Various aspects of the present invention can be better understood by reference to the following Examples which are offered by way of illustration. The present invention is not limited to the Examples given herein.

### General Procedure for Producing Compounded Material.

A twin-screw vented extruder having 18-mm diameter co-rotating screw with a 40-56 L/D (i.e., L/D ratio of 40-56) is used for compounding. The unit has one main feeder and at least three side feeders. A feed rate of at least 1 kg/hr is used. The twin-screw co-rotating/turning at least 1000 RPM is sufficient to provide high shear for effective compounding. The total compounder throughput is at least 15 kg/hr.

The compounding unit has at least three vent ports: one atmospheric port and two vacuum ports. A knock-out pot is provided in this operation. The rotating twin screws impart forward momentum to the heated mass inside the barrel. The barrel is heated along its length to melt the polymer. Typically, 240-320° C. is used for nylon 66-containing compositions.

The processing section of the twin-screw compounder is set up to suit various process needs and to allow a wide variety of processes, such as compounding processes. Polymer, fillers, and additives (as desired) are continuously fed into the first barrel section of the twin screw using a metering feeder. The products are conveyed along the screw and are melted and mixed by kneading elements in the plastification section of the barrel. The polymer then travels along to a side port where fillers (if desired), such as but not limited to glass fiber, could be added. The polymer then travels on to degassing zones and from there to a pressure build zone where it then exits the die via an at least 3-mm hole as a lace. The cast lace is fed into a water bath to cool and to enable it to be cut into chips via a pelletizer. The unit is able to withstand at least 70 bar die pressure. A die with a minimum of four holes, each at least 3 mm diameter, is used for pelletizing.

The compounded pellet having a diameter of 3 mm and a length of 3-5 mm is produced using the above equipment. The moisture content of the pelletized material is <0.2 wt. %.

### Materials and Methods Used in the Examples.

Feedstock PA6 neat polyamide, as used herein, is commercially available from BASF as Ultramid® polyamide, DSM Engineering Materials as Akulon® polyamide or similar.

Feedstock PA66 polyamide, as used herein, is a commercially available INVISTA nylon 66 (or N66) grade under the Tradename INVISTA™ U4800 polyamide resin. The PA66 has standard RV range of 42-50. The feedstock PA66 may also have RV ranging from 20 to 240.

As used herein, “High-AEG polyamide 66” or “High AEG N66” is commercially available from INVISTA. High-AEG polyamide 66 is characterized by its RV range of 30-80, for example 35-75 RV, for example, 35-70 RV, and AEG of ≥65 milliequivalents per kg (meq/kg) and ≤130 meq/kg of the polyamide resin, for example ≥70 meq/kg and ≤125 meq/kg, ≥75 meq/kg and ≤125 meq/kg, ≥80 meq/kg and ≤125 meq/kg, ≥90 meq/kg and ≤120 meq/kg of the polyamide resin.

As used herein, the term “parison” is an extruded rounded mass of molten polymer formed into a tube shape with at least one open end. Forming a parison is an intermediate step in blow molding. After the parison is formed, then the parison is clamped into a blow mold and gas is injected into the interior open space of the parison. Similarly, in vacuum molding, gas is drawn into the interior open space of the parison by differential pressure when a vacuum is applied to draw the molten polymer outwardly into contact with the surface of a vacuum mold.

The term “stable parison”, as used herein, describes a parison that can be formed from a composition that passes the stable parison test. The stable parison is substantially free of imperfections such as holes or significantly thickened or thinned wall regions.

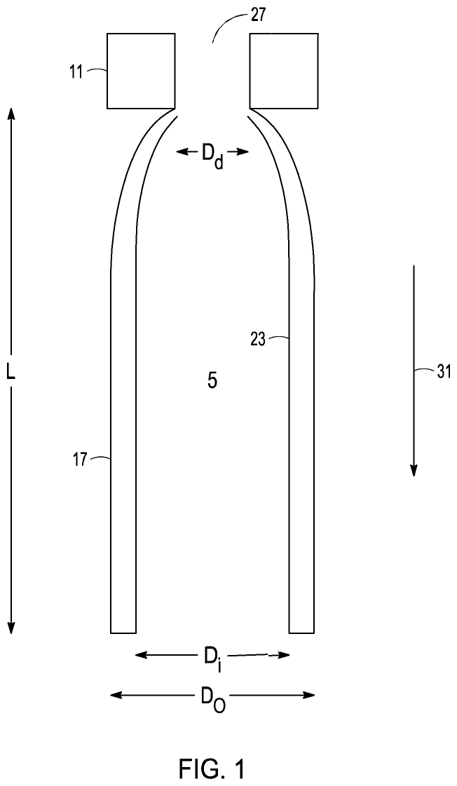

FIG. 1 is a schematic representation of the front-view cross-section of stable parison 5. A molten blow-moldable composition, according to the present disclosure, enters die 11 through its opening 27. The die opening has diameter Da. The stable parison formed is a linear, hollow, vertically hanging cylindrical object stretched in direction 31. It has a length of L, outside diameter D_{O} and inside diameter Dᵢ. The stable parison has outer surface 17 and inner surface 23. The stable parison has a substantially uniform wall thickness, i.e., one-half of (D_{O}−Dᵢ), around its circumference and throughout its linear length L. The compositions according to the present disclosure provide sufficient melt strength to prevent the stretched parison from sagging under its own weight while freely suspended. The stable parison has no structural breaks and no significantly thickened or thinned wall regions.

The term “stable parison test”, as used herein in the Examples, describes a test to determine whether a composition is blow-moldable. A composition passes the stable parison test if the composition can be extruded at 288° C. downwardly into a parison having a 7 mm wall thickness and a 25 mm outside diameter at a linear extrusion rate of 6-8 cm/sec to a length of 1 meter, and the wall thickness throughout remains above 6 mm and below 8 mm for at least 30 seconds after the hanging length of the parison reaches 1 meter.

The term “preform” as used herein means a relatively thick-walled hollow blank of a thermoplastic for stretch blow molding, for example, into polyethylene terephthalate (PET) beverage bottles. Preforms differ from parisons in that preforms are cooled and solidified, and are suitable for storage as preforms or for reheating and immediate use.

The term “melt strength” as used herein is defined in U.S. Pat. No. 5,576,387A (assigned to Sabic Innovative Plastics). An improvement in melt strength is evidenced by an increase in the R* value which is defined as the ratio of the low shear rate viscosity at 1 sec.⁻¹ of the composition to the high shear rate viscosity at 100 sec.⁻¹, at a predetermined optimum processing temperature: EQU R*=(viscosity at 1 sec.⁻¹)/(viscosity at 100 sec⁻¹). The concept of melt viscosity and R* value is further discussed in Abolins et al. U.S. Pat. No. 4,900,786.

As used herein, “Amplify© GR216” is a maleic anhydride grafted elastomer and is commercially available from Dow Chemical.

As used herein, “ZeMac E60” is a chain extender that is a copolymer of maleic anhydride and ethylene and is commercially available from Vertellus.

The formulation “PA66/DI” used in the examples of the present disclosure has an RV of 45, and a composition of 92:8 PA66:DI (wt/wt), with the “DI” part being about 40:60 D:I (wt/wt) or 50:50 D:I (molar).

As used herein, “Stabaxol® P100” is a type of hydrolysis stabilizer commercially available from Lanxess.

ASTM D789: Relative viscosity (RV) measurement method. Relative viscosity is the ratio of the viscosity of the polymer solution to the viscosity of the solvent used. For polyamides, RV is measured as an 8.4 wt % solution in 90 wt % formic acid, at room temperature and pressure, unless otherwise indicated. The solvent used is 90 wt % formic acid.

The term “AEG” is an abbreviation for amine end groups present in the polyamide resin and is measured in moles per million grams (mpmg) or milliequivalents per kg (meq/kg). AEG is determined by titration of polymer solution in solvent such as methanol/phenol.

Flammability testing is established by performing a test functionally equivalent to the UL 94 Standard.

ISO 527: Tensile strength (MPa) measurement and % elongation-at-break measurement method.

Blow molding: A blow-moldable composition including the polyamide composition, reaction product thereof, or a combination thereof, is provided to blow molding equipment.

### Example 1. Compounding of Polyamide Resins with Chain Extender Additive

Table 2 lists compositional ranges of several polyamide samples that are compounded using the general procedure detailed above.

TABLE 2
Samples A-G.

| | Examplary | | | | | | |
|---|---|---|---|---|---|---|---|
| Component | Range | | | | | | |
| [basis: wt. %] | Wt. % | A | B | C | D | E | F |
| PA66 (standard grade) | | — | — | — | — | — | 98.5 |
| High AEG PA66 (45 RV) | 20-75 | 74 | 42.3 | 73.75 | 73.5 | 37.8 | — |
| PA66/DI (45 RV) | 20-85 | — | 30 | — | — | 30 | — |
| PA6 | <10 | — | — | — | — | 4.5 | — |
| Impact modifier (Amplify ™ GR216 | 10-40 | 25 | 25 | 25 | 25 | 25 | — |
| or ExxonMobil VA1840) | | | | | | | — |
| Chain extender (ZeMac E60) | 0.1-1 | — | — | 0.25 | 0.5 | — | — |
| Hydrolysis stabilizer (Stabaxol P100) | 0.1-3 | — | 0.5 | — | — | 0.5 | — |
| Black MB Colorant (carbon black or | 0.5-2.5 | — | 1.0 | — | — | 1.0 | 1.0 |
| nigrosine black dye) | | | | | | | |
| Heat stabilizer (Cu-based or organic | 0.5-2 | 1.0 | 1.2 | 1.0 | 1.0 | 1.2 | 0.5 |
| based such as Irganox ® B1171) | | | | | | | |
| Reinforcement additive (glass fibers) | | 0 | 0 | 0 | 0 | 0 | 0 |
| TOTAL | | 100 | 100 | 100 | 100 | 100 | 100 |

The compounding for the Table 2 compositions is performed using a conventional screw type extruder and in the 240-265° C. temperature range. Also, no reinforcement additive, such as glass fiber (GF), is present in the Table 2 compounded resins.

The above-compounded polyamide specimens A through F in Table 2 are obtained as cylindrical extruded pellets of dimension 2-4 mm diameter and 3-5 mm length.

### Example 2. Blow Molding of Compounded Resin “F” of Table 2

The formulation “F”, as described in Table 2, is fed to a blow molding processing step for preparing blow-molded parts of various shapes. It is noted that formulation “F” is difficult to blow mold into articles due to its poor melt strength, especially in the absence of any reinforcement additive (GF, for example).

### Example 3. Blow Molding of Compounded Resin “B” of Table 2

The formulation “B”, as described in Table 2, is fed to a blow molding processing step for preparing blow-molded parts of various shapes. Surprisingly, the formulation “B” displays great processability and superior melt strength during blow molding and in the absence of any reinforcement additives. Various blow-molded articles are obtained having the wall thicknesses in the 0.5-20 mm range and of aspect ratios (L/D) in the 0.5-75 range. An aspect ratio is defined as an arithmetic ratio of the overall linear length of a shaped article over its diametric distance. For illustrative purposes, a shaped blow-molded article of 50 cm linear length (L) and 10 cm overall diameter (D) will have the aspect ratio of 5.

### Example 4. Suction Blow Molding of Compounded Resin “B” of Table 2

The test material had 255° C. melt point temperature, 1.04 g/cc density, and 3.1 g/10 cc MFR value (290° C./15 kg conditions). The test material is dried using −30° C. dew point air at >100° C. temperature in an industrial-size desiccant drying system.

The molded part resembles a three-dimensional, hollow, duct-like piece having about 25 mm outer diameter×90 mm developed length and about 2-2.5 mm wall thickness. The duct-like piece includes a combination of straight sections and several helical/curved sections for testing the mold quality at tight curves/bends.

The processability of the test material in suction blow molding is evaluated by observing the melt strength, swelling ratio, elasticity/toughness, outer/inner part appearance aspects, and material stability, as described below.

Melt Strength and Swelling Ratio. The melt strength is determined by expulsion of a parison and time measurement until the parison hits the lower plate of the machine. The expulsion speed and die gap-opening are kept constant. During the dynamic expulsion, the parison is stretched under its own weight. The drop-time is then related to the parison strength. The test conditions are: 1.8 m drop height, 2% expulsion speed, 50% die gap. Three melt temperatures are used during the parison drop test (“PDT”).

The measured drop times are: 27 sec (at 276° C.), 26 sec (at 285° C.), and 25 sec (at 295° C.). The 20° C. increase in the melt temperature only slightly affects the parison strength.

The swelling ratio is determined by dividing the parison outer diameter by the die diameter. For all the above melt temperatures, the swelling ratio is 2.13 (17 mm parison diameter/8 mm die diameter). The data indicates that the swelling ratio is not impacted by the 20° C. increase in the melt temperature.

Elasticity Toughness. The obtained parison is manually stretched and no breakage is noticed even after about 4-5× elongation. It is qualitatively observed that the tested material has a high elasticity and toughness, which should help to control the thickness in the highly stretched areas of molded parts formed therefrom (for example, outer regions of a tightly curved duct section).

Outer/Inner Part Appearance Aspects. A visual inspection of the molded parts shows acceptable appearance aspects for both, inner and outer surfaces. The appearance of the parison is sufficiently uniform for the purposes of molding as disclosed herein.

Material Stability. The material appears to be stable during the operation and <3 min. hold-up times. The material shows signs of reactivity as the hold-up times are >10 min. Note that the hold-up time of the material in the plasticization unit will depend on the unit's accumulation capacity, the weight of the part and cycle time, all of which can be adjusted for the desired effect.

### Example 5. Reusability of Compounded Resin “B” of Table 2 in Blow Molding

The compounded resin material, as used in Examples 3-4, is tested as neat (0% Regrind), 70:30 neat:regrind, and 100% regrind (0% neat). All percentage values are on weight basis, unless indicated otherwise.

The regrind material is produced by regrinding once-molded parts obtained from the neat material. The grinding is done by rotating blades equipped with a 6-mm diameter calibrated grid. The regrind material is immediately dried at about 90° C. for 4 hours to minimize moisture pickup. An automatic blending device is used to prepare the 70:30 neat:regrind blend.

The melt processing temperatures are: 275° C. (min)/285° C. (optimum)/290° C. (max)/40-90° C. mold temperature. The blow-molded part resembles a hollow 3-dimensional air-duct-like part having about 42 mm average diameter×550 mm developed length, and approximately 380 grams of full weight in production.

The processability of each material is evaluated by measurement and comparison of: A) melt strength and swelling ratio, and B) process stability.

Comparison of melt strength and swelling ratio. The parison drop test (PDT) shows no significant impact with the use of regrind as parisons remains stable in all three cases. Table 3a shows the PDT results which are obtained using conditions of 1.36 m drop height, 8% expulsion speed, 50% die gap, and 288° C. melt temperature.

TABLE 3a
Melt strength determination via PDT

| | Material | Drop time |
|---|---|---|
| Example # | description | (sec) |
| 5a | neat resin | 25.5 |
| | (0% regrind) | |
| 5b | 70:30 neat:regrind | 26.7 |
| 5c | 100% regrind | 25.5 |
| | (0% neat) | |

The swelling ratio is determined by dividing the parison (outer) diameter with the die diameter. Table 3b shows the swelling ratio results for the three materials that are tested. The use of regrinds slightly increases the swelling ratio.

TABLE 3b
Swelling ratio determination

| | | Die dia. | Parison dia. | Swelling |
|---|---|---|---|---|
| Example # | Material description | (mm) | (mm) | ratio |
| 5a | Neat resin | 13 | 28 | 2.15 |
| | (0% regrind) | | | |
| 5b | 70:30 neat:regrind | 13 | 29 | 2.23 |
| 5c | 100% regrind | 13 | 29 | 2.23 |
| | (0% neat) | | | |

In addition, thickness measurements at various sections of the molded part, especially at the external sides of the curved sections where parisons get stretched the most, and length variations on consecutive molded parts shows that the use of regrinds: i) provides better control of the thickness distribution, and ii) provides stabilization of the production with better consistency in consecutive molded parts. This is observed to be in line with the slight increase in swelling ratio with the use of regrinds.

Comparison of process stability. The residence time of the material in the plasticization unit is known as hold-up time (“HUT” or “h.u.t”). It is determined by stopping the alimentation of the material in the plasticization machine and counting the number of parts (n) until the unit is empty. The number of parts (n) is multiplied by the cycle time, wherein, (n×cycle time (sec))/60=h.u.t (minutes). The h.u.t can be varied by modification of the cycle time.

In Table 3c, the process stability aspects are summarized for the materials that are tested, obtained using conditions of 13 mm die size, 299° C. melt temperature, 240-260 bars melt expulsion pressure, and 2.9-3.3 sec expulsion time.

TABLE 3c
Process stability aspects of the materials

| | | | | | | Molded part - thickness |
|---|---|---|---|---|---|---|
| | | Cycle | Blow | | | measurement @ three |
| | Material | time | time | h. u. t | Swelling | points |
| Ex. # | description | (sec) | (sec) | (min) | ratio | (with averages) in mm |
| 5a | Neat resin | 40 | 30 | 6 | 2.15 | 1.2; 1.7; 2.7 (1.87 avg.) |
| | (0% regrind) | 71 | 60 | 12 | | 1.2; 1.7; 2.6 (1.83 avg.) |
| | | 31 | 20 | 5 | | 1.2; 1.8; 2.7 (1.90 avg.) |
| 5b | 70:30 | 40 | 30 | 6 | 2.23 | 1.3; 1.9; 2.8 (2.00 avg.) |
| | neat:regrind | 70 | 60 | 12 | | 1.3; 1.9; 2.8 (2.00 avg.) |
| 5c | 100% regrind | 40 | 30 | 6 | 2.23 | 1.6; 2.1; 2.8 (2.17 avg.) |
| | (0% neat) | 70 | 60 | 12 | | 1.5; 2.0; 2.7 (2.07 avg.) |

The Table 3c process stability data indicates that the use of regrinds has little to no effect. Overall, the blow molding process and the molded parts dimensions remain stable with the use of regrinds as tested in Examples 5b and 5c in comparison with Example 5a.

Table 3d summarizes the mechanical performance data for the molded material including the regrind content.

TABLE 3d
Mechanical performance

| | | Tensile | Tensile | |
|---|---|---|---|---|
| | | strength at | strength at | |
| Ex. | Material | yield | break | Elongation at |
| ID. | Description | (MPa) | (MPa) | break (%) |
| 5a | Neat resin | 45 | 45 | 277 |
| | (0% regrind) | | | |
| 5b | 70:30 neat:regrind | 43 | 43 | 268 |
| 5c | 100% regrind | 42 | 44 | 268 |
| | (0% neat) | | | |

The visual appearance aspects for the blow molded parts shows that the use of regrind material slightly improves the outer surface aspects, while no major changes are observed for the inner surface aspects.

The above testing and data indicates that the composition “B” of Table 2 can be processed including a percentage of regrind material that fits with conventional blow molding needs. The recommended regrind material size can be about 6 mm with proper drying before introduction of any neat material.

### Example 6. Stable Parison Test for Samples A-F and G-M

Sample B passes the stable parison test, wherein it is extruded at 288° C. downwardly into a parison having a 7 mm wall thickness and a 25 mm outside diameter at a linear extrusion rate of 6-8 cm/sec to a length of 1 meter, and the wall thickness throughout remains above 6 mm and below 8 mm for at least 30 seconds after the hanging length of the parison reaches 1 meter. The maximum difference in wall thickness from the initial thickness is 0.5 mm, or about 7.1% of 7 mm.

Samples A, C, and D pass the stable parison test. The maximum difference in wall thickness is 14% of 7 mm, 13% of 7 mm, and 12% of 7 mm, respectively.

Sample E passes the stable parison test. The maximum difference in wall thickness is 7.5% of 7 mm.

Sample F fails the stable parison test, with multiple portions of the parison reaching wall thicknesses below 6 mm or above 8 mm after 30 seconds after attaining the 1 m length.

Table 4 shows additional samples that are compounded according to the procedure of Example 1 and then subjected to the stable parison test. In Table 4, “P” indicates that the sample passes the stable parison test, and “F” indicates that the sample fails the stable parison test. In Table 4, “Stable parison test maximum difference from extruded wall thickness” indicates the maximum difference in wall thickness after 30 seconds after attaining the 1 m length, in terms of the percentage of the original wall thickness.

TABLE 4
Additional samples.

| Component | | | | | | | | | | | | | |
|---|---|---|---|---|---|---|---|---|---|---|---|---|---|
| [basis: wt. %] | G | H | I | J | K | F | G | H | I | J | K | L | M |
| PA66 (standard grade) | — | — | — | — | — | — | — | — | — | — | — | — | 44 |
| High AEG PA66 (45 | 35 | 25 | 94 | 73 | 19 | 29 | 59 | 64 | 54 | 39 | 14 | 44 | — |
| RV) | | | | | | | | | | | | | |
| PA66/DI (45 RV) | 39 | 49 | — | 21 | 55 | 45 | 15 | 10 | 30 | 30 | 30 | 30 | 30 |
| PA6 | — | — | — | — | — | — | — | — | — | — | — | — | — |
| Impact modifier | 25 | 25 | 5 | 5 | 25 | 25 | 25 | 25 | 15 | 30 | 55 | 20 | 25 |
| (Amplify ™ GR216 or | | | | | | | | | | | | | |
| ExxonMobil VA1840) | | | | | | | | | | | | | |
| Chain extender | — | — | — | — | — | — | — | — | — | — | — | 5 | — |
| (ZeMac E60) | | | | | | | | | | | | | |
| Hydrolysis stabilizer | — | — | — | — | — | — | — | — | — | — | — | — | — |
| (Stabaxol P100) | | | | | | | | | | | | | |
| Black MB Colorant | — | — | — | — | — | — | — | — | — | — | — | — | — |
| (carbon black or | | | | | | | | | | | | | |
| nigrosine black dye) | | | | | | | | | | | | | |
| Heat stabilizer (Cu- | 1.0 | 1.0 | 1.0 | 1.0 | 1.0 | 1.0 | 1.0 | 1.0 | 1.0 | 1.0 | 1.0 | 1.0 | 1.0 |
| based or organic based | | | | | | | | | | | | | |
| such as Irganox ® | | | | | | | | | | | | | |
| B1171) | | | | | | | | | | | | | |
| Reinforcement | 0 | 0 | 0 | 0 | 0 | 0 | 0 | 0 | 0 | 0 | 0 | 0 | 0 |
| additive (glass fibers) | | | | | | | | | | | | | |
| TOTAL | 100 | 100 | 100 | 100 | 100 | 100 | 100 | 100 | 100 | 100 | 100 | 100 | 100 |
| Stable parison test | P | F | F | F | F | P | P | P | P | P | F | P | P |
| result at 288° C. | | | | | | | | | | | | | |
| Stable parison test | 11 | — | — | — | — | 10 | 13 | 14 | 9 | 8 | — | 7.5 | 14 |
| maximum difference | | | | | | | | | | | | | |
| from extruded wall | | | | | | | | | | | | | |
| thickness (% of | | | | | | | | | | | | | |
| extruded wall | | | | | | | | | | | | | |
| thickness) | | | | | | | | | | | | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of the present invention.

### Exemplary Aspects

The following exemplary aspects are provided, the numbering of which is not to be construed as designating levels of importance:

Aspect 1 provides a blow-moldable composition comprising:
a polyamide composition, a reacted composition that is a reaction product of the polyamide composition, or a combination thereof, the polyamide composition comprising
   ≥30 wt % to ≤90 wt % polyamide-6,6,
   from ≥0 wt % to ≤2 wt % of a reinforcing fiber, or from ≥0 wt % to ≤1 wt % of the reinforcing fiber, or from ≥0 wt % to ≤0.1 wt % of the reinforcing fiber,
   from ≥10 wt % to ≤50 wt % of a maleic anhydride-grafted polyolefin.

Aspect 2 provides the blow-moldable composition of Aspect 1, wherein the reinforcing fiber is glass fiber.

Aspect 3 provides the blow-moldable composition of any one of Aspects 1-2, wherein the polyamide-6,6 is from ≥30 wt % to ≤70 wt % of the polyamide composition.

Aspect 4 provides the blow-moldable composition of any one of Aspects 1-3, wherein the polyamide-6,6 is from ≥40 wt % to ≤50 wt % of the polyamide composition.

Aspect 5 provides the blow-moldable composition of any one of Aspects 1-4, wherein the polyamide-6,6 has an AEG of ≥65 milliequivalents per kg (meq/kg) and ≤130 meq/kg.

Aspect 6 provides the blow-moldable composition of any one of Aspects 1-5, wherein the polyamide composition further comprises a PA66 copolymer.

Aspect 7 provides the blow-moldable composition of Aspect 6, wherein the PA66 copolymer is from ≥10 wt % to ≤50 wt % of the polyamide composition.

Aspect 8 provides the blow-moldable composition of any one of Aspects 6-7, wherein the PA66 copolymer is from ≥25 wt % to ≤35 wt % of the polyamide composition.

Aspect 9 provides the blow-moldable composition of any one of Aspects 6-8, wherein the PA66 copolymer is nylon 66/6T, nylon 66/DI, nylon 66/D6, nylon 66/DT, nylon 66/610, nylon 66/612.

Aspect 10 provides the blow-moldable composition of any one of Aspects 6-9, wherein the PA66 copolymer is PA66/DI.

Aspect 11 provides the blow-moldable composition of any one of Aspects 6-10, wherein the PA66 copolymer is PA66/DI, and wherein the PA66 copolymer is from ≥25 wt % to ≤35 wt % of the polyamide composition.

Aspect 12 provides the blow-moldable composition of any one of Aspects 1-11, wherein the maleic anhydride-grafted polyolefin has a grafted maleic anhydride incorporation of ≥0.05 wt % to ≤1.5 wt % based on a total weight of the maleic anhydride-grafted polyolefin.

Aspect 13 provides the blow-moldable composition of any one of Aspects 1-12, wherein the polyamide composition further comprises a chain extender.

Aspect 14 provides the blow-moldable composition of Aspect 13, wherein the chain extender is ≥0.01 wt % to ≤5 wt % of the polyamide composition.

Aspect 15 provides the blow-moldable composition of any one of Aspects 13-14, wherein the chain extender is ≥0.1 wt % to ≤1 wt % of the polyamide composition.

Aspect 16 provides the blow-moldable composition of any one of Aspects 13-15, wherein the chain extender comprises a dialcohol, a bis-epoxide, a polymer comprising epoxide functional groups, a polymer comprising anhydride functional groups, a bis-N-acyl bis-caprolactam, a diphenyl carbonate, a bisoxazoline, an oxazolinone, a diisocyanate, an organic phosphite, a bis-ketenimine, a dianhydride, a carbodiimide, a polymer comprising carbodiimide functionality, or a combination thereof.

Aspect 17 provides the blow-moldable composition of any one of Aspects 13-16, wherein the chain extender is a maleic anhydride-polyolefin copolymer, such as an alternating copolymer of maleic anhydride and ethylene.

Aspect 18 provides the blow-moldable composition of any one of Aspects 13-17, wherein the chain extender is a maleic anhydride-polyolefin copolymer, and wherein the chain extender is ≥0.1 wt % to ≤1 wt % of the polyamide composition.

Aspect 19 provides the blow-moldable composition of any one of Aspects 13-18, wherein the chain extender, or domains thereof, is/are uniformly distributed in the polyamide composition and/or the reacted product thereof.

Aspect 20 provides the blow-moldable composition of any one of Aspects 1-19, wherein the polyamide composition further comprises a modified polyphenylene ether, an impact modifier, a flame retardant, a chain extender, a heat stabilizer, a colorant additive, a filler, a conductive fiber, another polyamide other than the polyamide-6,6, or a combination thereof.

Aspect 21 provides the blow-moldable composition of any one of Aspects 1-20, wherein the blow-moldable composition comprises the polyamide composition.

Aspect 22 provides the blow-moldable composition of any one of Aspects 1-21, wherein the blow-moldable composition comprises the reacted composition that is the reaction product of the polyamide composition.

Aspect 23 provides the blow-moldable composition of any one of Aspects 1-22, wherein the blow-moldable composition comprises the polyamide composition and the reacted composition that is the reaction product of the polyamide composition.

Aspect 24 provides the blow-moldable composition of any one of Aspects 1-23, wherein the polyamide-6,6 is from ≥40 wt % to ≤50 wt % of the polyamide composition, and wherein the polyamide composition further comprises PA66/DI that is from ≥25 wt % to ≤35 wt % of the polyamide composition.

Aspect 25 provides the blow-moldable composition of any one of Aspects 1-24, further comprising from ≥0 to ≤10% by weight of nylon-6.

Aspect 26 provides the blow-moldable composition of any one of Aspects 1-25, wherein the blow-moldable composition exhibits sufficient melt strength to form a parison in a blow molding apparatus, wherein the parison hangs substantially vertically.

Aspect 27 provides the blow-moldable composition of any one of Aspects 1-26, wherein the blow-moldable composition forms a parison that:
remains substantially stable in an open split mold of a blow molding process for time ≥1 second and ≤60 second.

Aspect 28 provides the blow-moldable composition of Aspect 27, wherein the parison is blow-moldable at ratios of volume to surface area selected from:
≥2 and ≤20;
≥10 and ≤20; and
≥2 and ≤4.

Aspect 29 provides the blow-moldable composition of any one of Aspects 1-28, wherein the blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

Aspect 30 provides the blow-moldable composition of any one of Aspects 1-29, wherein the blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 15% of Wᵢ for at least 30 seconds after the length of 1 meter is reached.

Aspect 31 provides the blow-moldable composition of any one of Aspects 1-30, wherein the blow-moldable composition is extrudable downwardly at a temperature of 260° C. to 310° C. into a parison having a wall thickness of 7 mm and a 25 mm outside diameter at a linear extrusion rate of 6-8 cm/sec to a length of 1 meter, and a wall thickness of the parison throughout remains above 6 mm and below 8 mm for at least 30 seconds after the length of 1 meter is reached.

Aspect 32 provides the blow-moldable composition of any one of Aspects 1-31, wherein a parison formed from the blow-moldable composition retains sufficient melt strength under blow molding conditions to form a continuous hollow molding having a wall thickness of ≥0.5 mm to ≤20 mm.

Aspect 33 provides the blow-moldable composition of any one of Aspects 1-32, wherein a parison formed from the blow-moldable composition retains sufficient strength to form a continuous hollow molding having aspect ratios from ≥0.5 to ≥75.

Aspect 34 provides the blow-moldable composition of any one of Aspects 1-33, wherein the maleic anhydride-grafted polyolefin, or domains thereof, is/are uniformly distributed in the polyamide composition and/or the reacted product thereof.

Aspect 35 provides the blow-moldable composition of any one of Aspects 1-34, wherein 0.01 wt % to 100 wt % of the polyamide composition comprises a blow-molded composition that is reused in the blow-moldable composition.

Aspect 36 provides the blow-moldable composition of Aspect 35, wherein 30 wt % to 100 wt % of the polyamide composition comprises a blow-molded composition that is reused in the blow-moldable composition.

Aspect 37 provides the blow-moldable composition of any one of Aspects 35-36, wherein the blow-molded composition that is reused in the blow-moldable composition is ground prior to incorporation into the polyamide composition of any one of Aspects 1-44.

Aspect 38 provides the blow-moldable composition of any one of Aspects 35-37, wherein the blow-molded composition that is reused in the blow-moldable composition is formed to a particle size of 10 mm or less prior to incorporation into the polyamide composition of any one of Aspects 1-44.

Aspect 39 provides the blow-moldable composition of any one of Aspects 35-38, wherein a parison formed from the blow-moldable composition has a swell ratio that is substantially the same as a swell ratio of a parison formed during formation of the blow-molded article that is reused in the blow-moldable composition.

Aspect 40 provides a blow-moldable composition comprising:
a polyamide composition, a reacted composition that is a reaction product of the polyamide composition, or a combination thereof, the polyamide composition comprising:
   ≥30 wt % to ≤90 wt % polyamide-6,6,
   from ≥0 wt % to ≤10 wt % of a reinforcing fiber, and
   from ≥0 to ≤1 wt % of nylon-6;
wherein the blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

Aspect 41 provides the blow-moldable composition of Aspect 40, wherein the polyamide composition comprises at least one selected from:
≥0 to ≤10 wt. % glass fibers;
≥0 to ≤5 wt. % glass fibers; and
≥0 to ≤2 wt. % glass fibers.

Aspect 42 provides a blow-moldable composition comprising:
a polyamide composition, a reacted composition that is a reaction product of the polyamide composition, or a combination thereof, the polyamide composition comprising
   ≥30 wt % to ≤90 wt % polyamide-6,6, and
   from ≥0 wt % to ≤10 wt % of a reinforcing fiber;
wherein the blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

Aspect 43 provides the blow-moldable composition of Aspect 42 wherein the parison is blow-moldable at ratios of volume to surface area selected from:
≥2 and ≤20;
≥10 and ≤20; and
≥2 and ≤4.

Aspect 44 provides a blow-moldable composition comprising
a polyamide composition, a reacted composition that is a reaction product of the polyamide composition, or a combination thereof, the polyamide composition comprising
   ≥40 wt % to ≤50 wt % polyamide-6,6,
   from ≥0 wt % to ≤2 wt % of a reinforcing fiber,
   PA66/DI that is from ≥25 wt % to ≤35 wt % of the polyamide composition, and
   from ≥10 wt % to ≤50 wt % of a maleic anhydride-grafted polyolefin, the maleic anhydride-grafted polyolefin having a grafted maleic anhydride incorporation of ≥0.05 to ≤1.5 wt % based on total weight of the maleic anhydride-grafted polyolefin;
wherein the blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

Aspect 45 provides a blow molded article comprising the blow-moldable composition of any one of Aspects 1-44.

Aspect 46 provides the blow molded article of Aspect 45, wherein the blow molded article has a wall thickness in the range of ≥0.5 mm to ≤20 mm.

Aspect 47 provides the blow molded article of any one of Aspects 45-46, wherein the article comprises aspect ratios from ≥0.5 to ≤75.

Aspect 48 provides a blow molded article comprising:
a polyamide composition, a reacted composition that is a reaction product of the polyamide composition, or a combination thereof, the polyamide composition comprising
   ≥40 wt % to ≤50 wt % polyamide-6,6,
   from ≥0 wt % to ≤2 wt % of a reinforcing fiber,
   PA66/DI that is from ≥25 wt % to ≤35 wt % of the polyamide composition, and
   from ≥10 wt % to ≤50 wt % of a maleic anhydride-grafted polyolefin, the maleic anhydride-grafted polyolefin having a grafted maleic anhydride incorporation of ≥0.05 to ≤1.5 wt % based on total weight of the maleic anhydride-grafted polyolefin.

Aspect 49 provides a method of making the blow-moldable composition of any one of Aspects 1-44, the method comprising:
combining the polyamide-6,6 and the maleic anhydride-grafted polyolefin to form the blow-moldable composition of any one of Aspects 1-44.

Aspect 50 provides the method of Aspect 49, wherein the method comprises combining the polyamide-6,6 and the maleic anhydride-grafted polyolefin prior to adding a chain extender thereto.

Aspect 51 provides the method of any one of Aspects 49-50, comprising:
providing to a first compounder extruder zone a feed comprising the polyamide-6,6 and the maleic anhydride-grafted polyolefin;
maintaining the first compounder extruder zone conditions sufficient to obtain a first compounded polyamide melt inside the first compounder extruder zone;
introducing a chain extender to the first compounded polyamide melt in a second compounder extruder zone; and
maintaining the second compounder extruder zone conditions sufficient to obtain a second compounded polyamide melt inside the second compounder extruder zone, wherein the second compounded polyamide melt is the blow-moldable composition of any one of Aspects 1-44.

Aspect 52 provides the method of Aspect 51, wherein the first compounder extruder zone is substantially free of the chain extender.

Aspect 53 provides the method of any one of Aspects 51-52, wherein the first compounder extruder zone is substantially free of chain extenders.

Aspect 54 provides the method of any one of Aspects 51-53, wherein the chain extender is ≥0.01 to ≤5 wt % of the second compounded polyamide melt.

Aspect 55 provides the method of any one of Aspects 51-54, wherein a barrel of a screw extruder (e.g., a single screw extruder, a vented twin-screw extruder, or an unvented twin-screw extruder) comprises the first compounder extruder zone and the second compounder extruder zone, wherein the providing of the feed to the first compounder extrusion zone comprises providing the feed to a feed inlet of the barrel, wherein the barrel has a length.

Aspect 56 provides the method of Aspect 55, wherein the chain extender is introduced to the second compounder extruder zone at least ¼ of the length of the barrel from the feed inlet of the barrel.

Aspect 57 provides the method of any one of Aspects 55-56, wherein the chain extender is introduced to the second compounder extruder zone at least ½ of the length of the barrel from the feed inlet of the barrel.

Aspect 58 provides the method of any one of Aspects 55-57, wherein the chain extender is introduced to the second compounder extruder zone at least ¾ of the length of the barrel from the feed inlet of the barrel.

Aspect 59 provides the method of any one of Aspects 55-58, wherein the chain extender is introduced to the second compounder extruder zone at least ¼ of the length of the barrel from the feed inlet of the barrel and sufficiently far from an outlet of the barrel to provide mixing of the chain extender with the first compounded polyamide melt to form the second compounded polyamide melt.

Aspect 60 provides the method of any one of Aspects 51-59, wherein the introducing of the chain extender to the first compounded polyamide melt in the second compounder extruder zone comprises introducing the chain extender to the first compounded polyamide melt after at least 50 wt % of the maleic anhydride-grafted polyolefin has incorporated into the first ompounded polyamide melt.

Aspect 61 provides the method of Aspect 60, wherein the incorporation into the polyamide-6,6 comprises homogeneous blending (e.g., on a molecular level, or of domains of the maleic anhydride-grafted polyolefin or a reaction product thereof).

Aspect 62 provides the method of any one of Aspects 60-61, wherein the incorporation into the first compounded polyamide melt comprises formation of a reaction product of the maleic anhydride-grafted polyolefin.

Aspect 63 provides the method of any one of Aspects 60-62, wherein the incorporation into the first compounded polyamide melt comprises reaction of the maleic anhydride-grafted polyolefin with the polyamide-6,6.

Aspect 64 provides the method of any one of Aspects 60-63, wherein the incorporation into the first compounded polyamide melt comprises formation of domains of the maleic anhydride-grafted polyolefin or a reaction product thereof in the polyamide-6,6.

Aspect 65 provides the method of any one of Aspects 60-64, wherein the introducing of the chain extender to the first compounded polyamide melt in the second compounder extruder zone comprises introducing the chain extender to the first compounded polyamide melt after at least 60 wt % of the maleic anhydride-grafted polyolefin has incorporated into the polyamide-6,6.

Aspect 66 provides the method of any one of Aspects 60-65, wherein the introducing of the chain extender to the first compounded polyamide melt in the second compounder extruder zone comprises introducing the chain extender to the first compounded polyamide melt after at least 70 wt % of the maleic anhydride-grafted polyolefin has incorporated into the polyamide-6,6.

Aspect 67 provides the method of any one of Aspects 60-66, wherein the introducing of the chain extender to the first compounded polyamide melt in the second compounder extruder zone comprises introducing the chain extender to the first compounded polyamide melt after at least 80 wt % of the maleic anhydride-grafted polyolefin has incorporated into the polyamide-6,6.

Aspect 68 provides the method of any one of Aspects 60-67, wherein the introducing of the chain extender to the first compounded polyamide melt in the second compounder extruder zone comprises introducing the chain extender to the first compounded polyamide melt after at least 90 wt % of the maleic anhydride-grafted polyolefin has incorporated into the polyamide-6,6.

Aspect 69 provides the method of any one of Aspects 60-68, wherein the introducing of the chain extender to the first compounded polyamide melt in the second compounder extruder zone comprises introducing the chain extender to the first compounded polyamide melt after about 100 wt % of the maleic anhydride-grafted polyolefin has incorporated into the polyamide-6,6.

Aspect 70 provides a method of making a blow molded article from the blow-moldable composition of any one of Aspects 1-44, the method comprising blow molding the blow-moldable composition of any one of Aspects 1-44 to form the blow molded article.

Aspect 71 provides a blow-moldable composition, article, or method of any one or any combination of Aspects 1-70, wherein the blow-moldable composition contains less than 1 wt % of a reinforcing fiber.

Aspect 72 provides a blow-moldable composition, article, or method of any one or any combination of Aspects 1-70, wherein the blow-moldable composition contains less than 0.1 wt % of a reinforcing fiber.

Aspect 73 provides the blow-moldable composition, article, or method of any one or any combination of Aspects 1-72 optionally configured such that all elements or options recited are available to use or select from.

What is claimed is:

1. A blow-moldable composition comprising:
a polyamide composition, a reacted composition that is a reaction product of the polyamide composition, or a combination thereof, the polyamide composition comprising
≥30 wt % to ≤90 wt % polyamide-6,6,
from ≥0 wt % to ≤2 wt % of a reinforcing fiber, and
from ≥10 wt % to ≤50 wt % of a maleic anhydride-grafted polyolefin.

2. The blow-moldable composition of claim 1, wherein the reinforcing fiber is glass fiber.

3. The blow-moldable composition of claim 1, wherein the polyamide-6,6 is from ≥30 wt % to ≤70 wt % of the polyamide composition.

4. The blow-moldable composition of claim 1, wherein the polyamide-6,6 has an AEG of ≥65 milliequivalents per kg (meq/kg) and ≤130 meq/kg.

5. The blow-moldable composition of claim 1, wherein the polyamide composition further comprises a PA66 copolymer.

6. The blow-moldable composition of claim 5, wherein the PA66 copolymer is from ≥25 wt % to ≤35 wt % of the polyamide composition, and wherein the PA66 copolymer is nylon 66/6T, nylon 66/DI, nylon 66/D6, nylon 66/DT, nylon 66/610, nylon 66/612.

7. The blow-moldable composition of claim 5, wherein the PA66 copolymer is PA66/DI.

8. The blow-moldable composition of claim 1, wherein the maleic anhydride-grafted polyolefin has a grafted maleic anhydride incorporation of ≥0.05 wt % to ≤1.5 wt % based on a total weight of the maleic anhydride-grafted polyolefin.

9. The blow-moldable composition of claim 1, wherein the polyamide composition further comprises a chain extender.

10. The blow-moldable composition of claim 9, wherein the chain extender is a maleic anhydride-polyolefin copolymer, and wherein the chain extender is ≥0.1 wt % to ≤1 wt % of the polyamide composition.

11. The blow-moldable composition of claim 1, further comprising from ≥0 to ≤1% by weight of nylon-6.

12. The blow-moldable composition of claim 1, wherein the blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

13. The blow-moldable composition of claim 1, wherein the blow-moldable composition is extrudable downwardly at a temperature of 260° C. to 310° C. into a parison having a wall thickness of 7 mm and a 25 mm outside diameter at a linear extrusion rate of 6-8 cm/sec to a length of 1 meter, and a wall thickness of the parison throughout remains above 6 mm and below 8 mm for at least 30 seconds after the length of 1 meter is reached.

14. The blow-moldable composition of claim 1, wherein a parison formed from the blow-moldable composition retains sufficient melt strength under blow molding conditions to form a continuous hollow molding having a wall thickness of ≥0.5 mm to ≤20 mm and/or having aspect ratios of from ≥0.5 to ≥75, and/or wherein a parison formed from the blow-moldable composition is blow-moldable at ratios of volume to surface area selected from:
≥2 and ≤20,
≥10 and ≤20, and
≥2 and ≤4.

15. The blow-moldable composition of claim 1, wherein the polyamide composition comprises a blow-molded article that is reused in the polyamide composition.

16. A blow-moldable composition comprising:
a polyamide composition, a reacted composition that is a reaction product of the polyamide composition, or a combination thereof, the polyamide composition comprising
≥30 wt % to ≤90 wt % polyamide-6,6, and
from ≥0 wt % to ≤10 wt % of a reinforcing fiber;
wherein the blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

17. A blow-moldable composition comprising
a polyamide composition, a reacted composition that is a reaction product of the polyamide composition, or a combination thereof, the polyamide composition comprising
≥40 wt % to ≤50 wt % polyamide-6,6,
from ≥0 wt % to ≤2 wt % of a reinforcing fiber,
PA66/DI that is from ≥25 wt % to ≤35 wt % of the polyamide composition, and
from ≥10 wt % to ≤50 wt % of a maleic anhydride-grafted polyolefin, the maleic anhydride-grafted polyolefin having a grafted maleic anhydride incorporation of ≥0.05 to ≤1.5 wt % based on total weight of the maleic anhydride-grafted polyolefin;
wherein the blow-moldable composition is extrudable downwardly at a temperature of 260° C. to 310° C. into a parison having a wall thickness of Wᵢ at a linear extrusion rate of 6-8 cm/sec to a length of 1 meter, and a wall thickness of the parison throughout differs from Wᵢ by less than 30% of Wᵢ for at least 30 seconds after the length of 1 meter is reached.

18. A blow molded article comprising the blow-moldable composition of claim 1.

19. A method of making the blow-moldable composition of claim 1, the method comprising:
combining the polyamide-6,6 and the maleic anhydride-grafted polyolefin to form the blow-moldable composition of claim 1.

20. A method of making a blow molded article from the blow-moldable composition of claim 1, the method comprising blow molding the blow-moldable composition of claim 1 to form the blow molded article.
